(19) United States
(12) Patent Application Publication
(10) Pub. No.: US 2020/0369251 A1
(43) Pub. Date: Nov. 26, 2020

(54) CONTROL METHOD OF A BRAKING SYSTEM OF AT LEAST ONE RAILWAY VEHICLE

(71) Applicant: FAIVELEY TRANSPORT ITALIA S.p.A., Piossasco (Torino) (IT)

(72) Inventors: Luc IMBERT, Torino (IT); Matteo FREA, Torino (IT)

(21) Appl. No.: 16/644,659

(22) PCT Filed: Sep. 6, 2018
(86) PCT No.: PCT/IB2018/056792

§ 371 Date: Mar. 5, 2020

(30) Foreign Application Priority Data
Sep. 7, 2017 (IT) 102017000100433

(51) Int. Cl. B60T 8/17; B60T 8/172; B60T 8/171; B60T 8/32; B60T 8/56

(52) U.S. Cl. CPC B60T 8/1703; B60T 8/172; B60T 8/56; B60T 8/3235; B60T 8/171

(57) ABSTRACT

A control method of a braking system of at least one railway vehicle comprising a plurality of deceleration influencing devices is provided. The control method includes calculating a deceleration difference between a target deceleration and at least an estimated effective deceleration; selecting at least one influencing device depending on the deceleration difference and decision factors, including a mission factor, advantage and disadvantage factors inherent to each deceleration influencing device, field response factors indicative of the environmental conditions surrounding the at least one railway vehicle, and system state factors; and controlling the selected at least one deceleration influencing device according to the deceleration difference and at least one of the decision factors.

### CROSS-REFERENCE TO RELATED APPLICATIONS

This application is a National Phase filing of PCT International Application No. PCT/IB2018/056792, having an International Filing Date of Sep. 6, 2018, claiming priority to Italian Patent Application No. 102017000100433, having a filing date of Sep. 7, 2017 each of which is hereby incorporated by reference in its entirety.

### FIELD OF THE INVENTION

The present invention relates, in general, to control methods for a railway vehicle, and in particular, to a control method of a braking system of at least one railway vehicle.

### BACKGROUND OF THE INVENTION

In most existing railway vehicle braking systems and methods, activation and control of braking systems, whether dependent or independent of adhesion, are operated independently of each other without any specific order or rule.

These systems do not provide for centralization of collection, analysis and management of the various braking options.

In some recent cases, however, a centralization of the various braking options based on the adhesion coefficient has been used. This approach, however, does not consider all possible interactions of factors that may affect the deceleration of the railway vehicle.

In other recent cases, a braking force is generated from an estimate of a desired braking force and an applied braking force. In this case, these estimates do not take into account any non-linear and atmospheric conditions. Therefore, the deceleration management will be sub-optimal.

For example, WO2016207078A2 describes a braking system wherein is provided a braking target, an accelerometer to determine braking power from deceleration and to adapt the current braking force at the braking force target. Only an individual estimate of the braking force of each component is described in this document.

In U.S. Pat. No. 9,126,605B2 a braking method is described for a railway vehicle which provides for a loss-of-adhesion signal and respective adhesion-type brakes. This document only describes the possibility of increasing the braking force on the axles where adhesion is available.

Furthermore, U.S. Pat. No. 9,254,830B2 only describes the generation of a braking force for the brake cylinder based on data from an accelerometer and wheel speed.

The aforesaid systems and methods do not optimize braking behavior as they do not present any general point of view, they do not take into account wear and the effectiveness of brake influencing devices. The aforesaid disadvantages thus lead to the non-utilization of the full braking potential of the railway vehicle and to the lack of the option of applying countermeasures to improve the braking of the railway vehicle.

As a result, in known systems, longer than expected braking distances frequently occur as a result of excessive wear on the brake influencing devices and, in particular, as a result of poor braking performance, which may lead to accidents.

### SUMMARY OF THE INVENTION

An object of the present invention is to propose a control method of a braking system of at least one railway vehicle which allows using full potential of the braking system of the railway vehicle and applying countermeasures to improve braking of the railway vehicle. In this way, braking distances and therefore accidents may be reduced.

In summary, to obtain this result, the control method of a braking system of at least one railway vehicle is based on the analysis of a desired target, i.e. the deceleration of the railway vehicle, so as to ensure a more complete and reliable approach to braking.

The aforesaid and other objects and advantages are achieved, according to an aspect of the present invention, by a control method of a braking system of at least one railway vehicle having the features described below. Preferred embodiments of the invention are also described.

The functional and structural characteristics of some preferred embodiments of a control method of a braking system of at least one railway vehicle according to the invention will now be described. Reference is made to the accompanying drawings.

### BRIEF DESCRIPTION OF THE DRAWINGS

FIG. 1 illustrates by way of example a system adapted to implement a control method of a braking system of at least one railway vehicle according to the invention;

FIG. 2 illustrates a block diagram of the internal structure of an adhesion management module of the system in FIG. 1; and

FIG. 3 illustrates a block diagram of the inner structure of an optimal adhesion control module of the adhesion management module in FIG. 2.

### DETAILED DESCRIPTION

Before explaining a plurality of embodiments of the invention in detail, it should be clarified that the invention is not limited in its application to the details of construction and to the configuration of the components provided in the following description or illustrated in the drawings. The invention may assume other embodiments and may be implemented or achieved in essentially different ways. It should also be understood that the phraseology and terminology have descriptive purposes and should not be construed as limiting. The use of “include” and “comprise” and the variations thereof are to be understood as encompassing the elements stated hereinafter and the equivalents thereof, as well as additional elements and the equivalents thereof.

The control method of a braking system of at least one railway vehicle comprising a plurality of deceleration influencing devices 2, in a first embodiment, comprises the step of calculating a deceleration difference between a target deceleration and at least an estimated effective deceleration, and the step of selecting at least one influencing device from among the plurality of deceleration influencing devices 2 according to the deceleration difference and the decision factors listed hereinafter.

The decision factors may be a mission factor indicating that the target deceleration to corresponds to service braking or emergency braking, or that a stretch traveled by the railway vehicle prevents the use of a particular deceleration influencing device, advantage and disadvantage factors inherent to each deceleration influencing devices indicative of positive and negative operating characteristics, field response factors indicative of the environmental conditions surrounding at least one railway vehicle and system state factors indicative of the current state of the braking system.

System state factors indicative of the current state of the braking system may comprise, among others, a factor indicative of the wear state of the braking system and/or a factor indicative of the current activation level of each deceleration influencing device 2.

The control method of a braking system of at least one railway vehicle further comprises the step of controlling the at least one influencing device selected according to the difference in deceleration and said decision factors, which, as already indicated above, may be a mission factor, advantage and disadvantage factors inherent to each deceleration influencing devices, field response factors and braking system state factors.

Each deceleration influencing device 2 may be a material injection device adapted to modify positively or negatively the friction coefficient between wheel and rail, and/or a brake acting on a disc or axle of electro-pneumatic, electrodynamic, mechanical, or hydraulic type, or a combination thereof, and/or a brake acting on wheels of electropneumatic, mechanical, or hydraulic type, and/or a brake acting on the rail, and/or wheel slide protection (WSP), and/or an eddy current brake.

Obviously, means for triggering a further deceleration of the train relative to its natural deceleration (air and rolling resistance and in some cases rail slope) are numerous. Some deceleration influencing devices may be connected to the same point of contact between the wheel and the rail, others may allow to change the properties of the points of contact between the wheel and the rail (also known as the cleaning effect) for greater deceleration. Other deceleration influencing devices allow the contact properties of the local contact point to be changed or allow the properties of the wheel/rail contact points to be changed and an independent contact point to be added.

Further deceleration influencing devices could be completely independent of the point of contact between wheel and rail.

The aforesaid deceleration influencing devices comprised in the deceleration control system may be controlled according to positive and negative operating characteristics, and/or according to the environmental conditions surrounding the railway vehicle. For example, the environmental conditions may comprise an adhesion value between the wheels of the railway vehicle and the rail.

By way of example, to select the appropriate deceleration influencing device, a simple table showing the main characteristics of each deceleration influencing device may be used.

In effect, the advantages and disadvantages of each deceleration influencing device are well known and may be weighed together, so as to activate the most suitable deceleration influencing device according to the two aforesaid main aspects.

As mentioned above, at least one deceleration influencing device may be controlled depending on whether the target deceleration corresponds to service braking or emergency braking.

The most relevant criteria may be the deceleration and the associated safety level for braking, in particular, the latter to avoid wear on the brake system.

The estimated effective deceleration may be measured by at least a first sensor and/or estimated as a function of the speed of at least one wheel of the railway vehicle measured by a second sensor.

In particular, the first sensor may be an accelerometer and the second sensor may be an angular speed sensor.

Obviously, to estimate the effective deceleration, the effective speed may be converted into an effective acceleration, for example, by calculating the derivative of the vehicle's speed.

The target deceleration, on the other hand, may be imparted by the driver by operating a predetermined brake lever or by a command given by an automatic train control derived from a signal, for example, a signal indicating the need to impose a lower speed than the current one on the railway vehicle.

Moreover, the step of controlling the at least one influencing device selected according to the difference in deceleration and the following decision factors may comprise the activation and deactivation of the selected influencing device. Alternatively, or in addition, it may also comprise adjusting the actuation intensity of the selected influencing devices. For example, a material injection device may be activated, deactivated, and/or the amount of material thereby injected may be controlled.

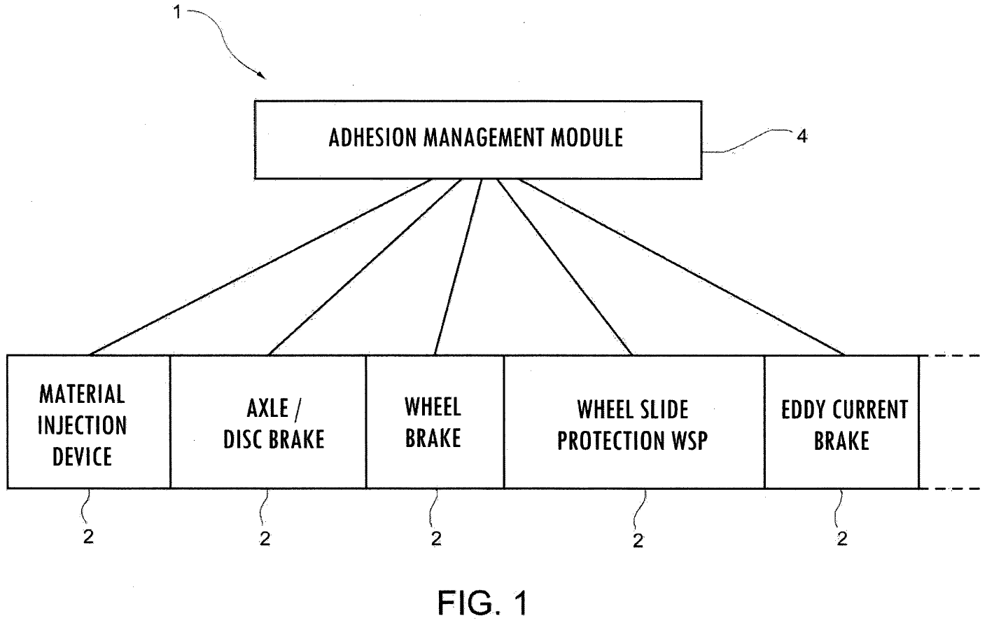

Referring now to FIG. 1, a system 1 arranged to implement the method described above is illustrated by way of example.

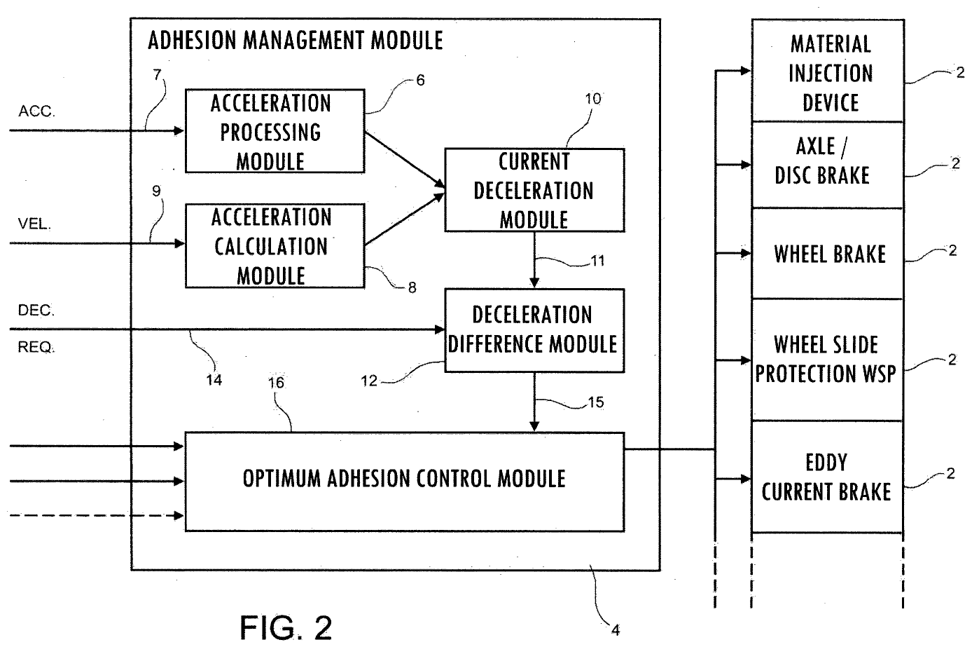

Such system 1 may comprise, as illustrated in FIG. 2, an adhesion management module 4 which comprises an acceleration processing module 6 and an acceleration calculation module 8. The acceleration processing module 6 receives the train's acceleration 7 by using a sensor, such as an accelerometer. The acceleration calculation module 8 receives the speed 9 of the train wheels and derives the acceleration therefrom. Both modules produce an estimate of the train's deceleration, which will be compared with each other. Such deceleration estimates may then be corrected in a further current deceleration module 10.

The current deceleration 11 of the train will be sent to a deceleration difference module 12. This module also receives the deceleration request 14 which may, for example, come from different sources, such as, among others, a BCU (brake control unit), a TCMS, and a digital signal.

The deceleration difference module then transmits the difference 15 between the deceleration request and the current deceleration to an optimal adhesion control module 16. The value of the difference between the deceleration request and the current deceleration may be positive or negative.

The optimum adhesion control module may decide which deceleration influencing device to activate based on, for example, the current state of the braking devices, the deceleration difference sign and amplitude and other signals.

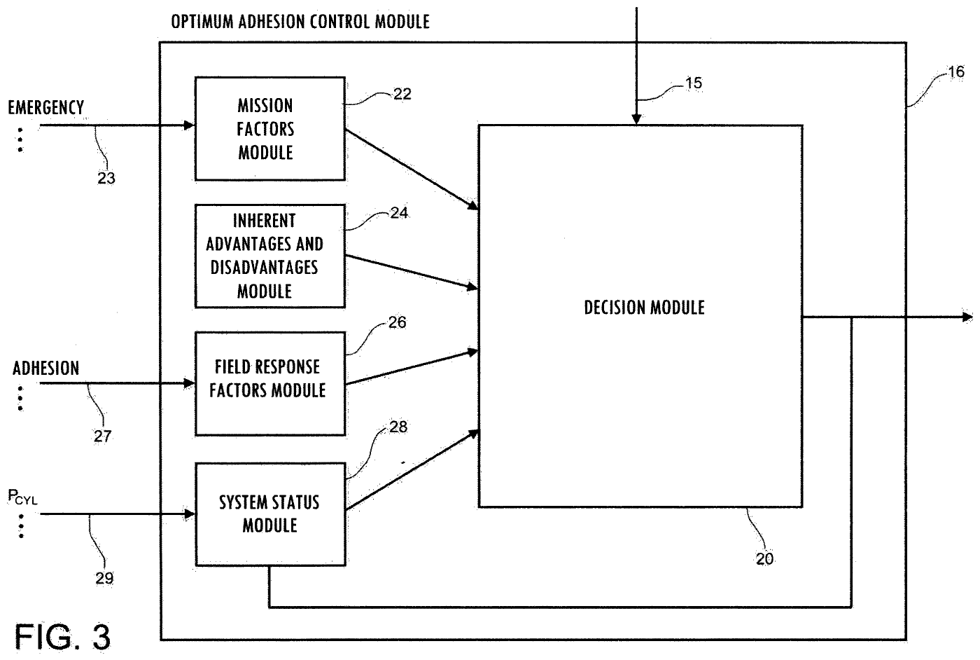

As illustrated in FIG. 3, the optimal adhesion control module 16 may comprise five modules:
a mission factors module 22 allowing the messages 23 coming from a signaling system or from the TCMS to be understood; an example could be the safety cycle (Emergency) and another example could be an MTB inhibition signal due to the particularities of the section of the route on which the railway vehicle is traveling;
a module of inherent advantages and disadvantages 24, which may comprise the table wherein are listed the characteristics of the various deceleration influencing devices. This module may also integrate past use preferences of different means;
a module of field response factors 26 analyzing the information 27 representing the state of the interfaces between the train and its surrounding environment, e.g. the state of the rail. This module may also propose suggestions on how to improve deceleration. The adhesion value and a macroscopic description of the surrounding environment may be examples of input that may be provided to this module;
a system state module 28 that allows one to understand the current system state and to compare it with the deceleration request commands 29, to understand any deviation between the command sent and the effective measured values. This module may also be used to calculate the remaining flexibility that the system has to offer. Other inputs may include the speed and the load of the train; the speed may influence the adhesion available between the wheel and the rail and the load may influence the force to be exerted in order to obtain a constant braking force regardless of the load. State variables may integrate one or more variables. Some examples may be:
   Pcyl;
   Speed;
   Sliding;
   Load;
   Availability of sand;
   Wear state.

The aforesaid four modules, comprised in the optimal adhesion control, and the deceleration difference value may be used in a decision module 20 which generates the activation commands of the various deceleration influencing devices.

Clearly, the system described above represents one of the possible control systems that could implement the control method of a braking system of at least one railway vehicle of the invention; however, the invention is not intended to be limited to this embodiment.

Advantageously, in the method and in the system described above, the control loop of a braking system of at least one railway vehicle is closed on the desired effect, i.e. deceleration. Thus, a control is put in place to ensure a more comprehensive approach.

Various aspects and embodiments of a system and of a control method of a braking system of at least one railway vehicle according to the invention have been described. It is understood that each embodiment may be combined with any other embodiment. The invention, moreover, is not limited to the described embodiments, but may be varied without departing from the scope of protection described and claimed herein.

1. A control method of a braking system of at least one railway vehicle that comprises a plurality of deceleration influencing devices, the control method including the steps of:
calculating a deceleration difference between a target deceleration and at least an estimated effective deceleration;
selecting at least one deceleration influencing device of said plurality of deceleration influencing devices depending on the deceleration difference and the following decision factors:
a) a mission factor indicative that the target deceleration corresponds to service braking or emergency braking, or that a section traveled by the at least one railway vehicle prevents use of a particular deceleration influencing device;
b) advantage and disadvantage factors inherent to each deceleration influencing device, indicative of positive and negative operating characteristics;
c) field response factors indicative of environment conditions surrounding the at least one railway vehicle;
d) system state factors indicative of a current state of the braking system;
controlling the selected at least one deceleration influencing device according to the deceleration difference and the following decision factors:
a) a mission factor indicative that the target deceleration corresponds to service braking or emergency braking, or that a section traveled by the at least one railway vehicle prevents the use of a particular deceleration influencing device;
b) advantage and disadvantage factors inherent to each deceleration influencing device, indicative of positive and negative operating characteristics;
c) field response factors indicative of the environment conditions surrounding the at least one railway vehicle;
d) system state factors indicative of the current state of the braking system.

2. The control method of claim 1, wherein each deceleration influencing device is selected from:
a material injection device adapted to modify a friction coefficient between wheel and rail,
a brake acting on disc or axle of a type selected from an electropneumatic type, an electrodynamic type, a mechanical type, a hydraulic type and combinations thereof,
a brake acting on wheels of a type selected from an electropneumatic type, mechanical type, and a hydraulic type,
a brake acting on the rail,
wheel slide protection WSP), and
an eddy current brake.

3. The control method of claim 1, wherein controlling the selected at least one deceleration influencing means device according to the deceleration difference and said decision factors comprises activation and deactivation of the selected deceleration influencing device and adjustment of activation intensity of the selected influencing device.

4. The control method of claim 1, wherein the at least an estimated effective deceleration is detected by at least one first sensor.

5. The control method of claim 4, wherein the at least one first sensor is an accelerometer.

6. The control method of claim 1, wherein at least one of said field response factors indicative of the environmental conditions surrounding the at least one rail railway vehicle is a factor indicative of an adhesion value between wheels of the at least one railway vehicle and the rail.

7. The control method of claim 1, wherein at least one of said system state factors indicative of the current state of the braking system is a factor indicative of braking system wear.

8. The control method of claim 1, wherein the target deceleration is a value given by a driver through actuation of a predetermined brake lever or a value corresponding to a command provided by an automatic train control derived from a signaling.

9. The control method of claim 1, wherein the at least an estimated effective deceleration is estimated according to a speed of at least one wheel of the at least one railway vehicle detected by a second sensor.

10. The control method of claim 9, wherein the second sensor is an angular speed sensor.

11. The control method of claim 1, wherein at least one of said system state factors indicative of the current state of the braking system is a factor indicative of a current activation level of each deceleration influencing device.
